(19) United States
(12) Patent Application Publication
(10) Pub. No.: US 2024/0182630 A1
(43) Pub. Date: Jun. 6, 2024

(54) RECYCLABLE AND DECOMPOSABLE EPOXY RESINS: COMPOSITIONS, PREPARATION METHODS AND APPLICATIONS IN CARBON FIBER REINFORCED COMPOSITES

(71) Applicant: SPERO RENEWABLES, LLC, Goleta, CA (US)

(72) Inventors: Shou ZHAO, Goleta, CA (US); Ian M. KLEIN, Goleta, CA (US)

(21) Appl. No.: 18/553,131

(22) PCT Filed: Mar. 25, 2022
(86) PCT No.: PCT/US2022/021932

§ 371 Date: Sep. 28, 2023

Related U.S. Application Data
(60) Provisional application No. 63/167,431, filed on Mar. 29, 2021.

(51) Int. Cl. C08G 59/50; C08G 59/16; C08G 59/24; C08G 59/32; C08J 5/04

(52) U.S. Cl. CPC C08G 59/5026; C08G 59/1455; C08G 59/245; C08G 59/3218; C08J 5/042; C08G 2170/00; C08J 2363/00

(57) ABSTRACT

A thermoset composition includes an epoxy prepolymer, an amine hardener, a reactive diluent, and an accelerator for crosslinking reactions. A method for making the degradable and recyclable epoxy resin includes mixing an epoxy prepolymer, an amine hardener, a reactive diluent, and an accelerator to form a mixture, degassing the mixture, and curing the mixture to for a resin.

### CROSS-REFERENCE TO RELATED APPLICATIONS

This application claims priority to U.S. Provisional Patent Application No. 63/167,431 filed on Mar. 29, 2021, and entitled “RECYCLABLE AND DECOMPOSABLE EPOXY RESINS: COMPOSITIONS, PREPARATION METHODS AND APPLICATIONS IN CARBON FIBER REINFORCED COMPOSITES,” which is incorporated herein in its entirety by reference.

### STATEMENT REGARDING FEDERALLY SPONSORED RESEARCH OR DEVELOPMENT

This invention was made with government support under Grant No. DE-EE0008929 awarded by the Department of Energy (DOE). The government has certain rights in the invention.

### FIELD OF THE DISCLOSURE

The present disclosure relates to the synthesis and applications of novel epoxy prepolymers. These prepolymers can be used for making decomposable and recyclable epoxy resins and carbon fiber reinforced composites (CFRCs), whose carbon fiber can be 100% recycled on demand without damaging its woven structure, sizing and strength. Manufacturing, reprocessing and applications of the resins and CFRCs are also disclosed.

### BACKGROUND

Epoxy resins are among the most versatile and widely used materials due to their mechanical strength, chemical and thermal resistance, and excellent insulation. However, because of irreversible covalent cross-links, epoxy resins cannot be remolded, reprocessed or recycled after their initial formation, which have created serious environmental issues. Epoxy resins have been widely used as matrix materials for carbon fiber reinforced composites (CFRCs). The lightweight and high strength of CFRCs have significantly improved fuel efficiency when used in aircrafts and automobiles. Especially, the low recharge mileage has been an important factor limiting the development of electric vehicles (EVs). By using lightweight CFRCs materials, the recharge mileage of EVs will be significantly improved. Thus, epoxy resin based CFRCs have huge market potential.

Limited studies on epoxy cross-linked CANs have been reported in the academic literature. For example, Leibler, et al. developed a malleable thermoset by epoxy-carboxylic acid reaction, while the malleability was realized through metal-catalyzed reversible transesterification at elevated temperature (Science, 2011, 334, 965-968; U.S. Pat. No. 9,562,132 B2). Zhang, et al. synthesized an epoxy-amine cross-linked thermoset embedded with Diels-alder (DA) bonds (Macromolecules, 2015, 48, 316-322). The thermoset could be converted to soluble polymers with the aid of sonication and cured into recycled thermoset via DA reaction. Odriozola, et al. used diglycidyl ether of bisphenol A (DGEBA) to react with a disulfide-containing amine hardener for making fiber-reinforced polymer composites, and the recyclability of composites was derived from the exchangeable disulfide bonds (Mater. Horiz., 2016, 3, 241-247).

However, these systems require hot press molding when recycled, expensive metal catalysts, and special treatments (e.g., sonication) when reprocessing.

In the patent literature several examples of covalently adaptable networks (CANs) have been described. For example, W. Zhang, et al. (University of Colorado) U.S. Pat. No. 9,453,099 (2016) developed a malleable and recyclable thermoset system. This system requires additional virgin monomer in recycling. Additionally, the thermoset was shown to have significant loss of strength when exposed to water.

CANs have also been incorporated in recyclable thermosets as disclosed in S. Pastine (Connora Technologies, Inc.) U.S. Pat. No. 8,785,694 (2014), S. Pasine, et al. (Connora Technologies, Inc.) U.S. Pat. No. 9,631,049 (2017), B. Liang, et al. (Adesso Advanced Materials Wuhu Co., Ltd.) U.S. Pat. No. 9,598,551 (2017), and S. Pastine (Connora Technologies, Inc.) U.S. Pat. No. 9,862,797 (2018). However, these systems require incorporation of acetal groups in the amine hardener, and these compounds are not commercially available and their syntheses are low yielding.

### SUMMARY

In some embodiments, a thermoset composition comprises an epoxy prepolymer, an amine hardener, a reactive diluent, and an accelerator for crosslinking reactions.

In some embodiments, a method for making the degradable and recyclable epoxy resin includes mixing an epoxy prepolymer, an amine hardener, a reactive diluent, and an accelerator to form a mixture, degassing the mixture, and curing the mixture to for a resin.

In addition, a process for synthesizing epoxy prepolymers with terminal epoxy and aldehyde groups is disclosed herein. Also disclosed herein is the compositions and syntheses of degradable and recyclable epoxy resin. Additionally, disclosed herein is the degradation and recycling methods for said epoxy resins. The method to collect carbon fiber from CFRCs is also disclosed herein.

These and other features will be more clearly understood from the following detailed description taken in conjunction with the accompanying drawings and claims.

### BRIEF DESCRIPTION OF THE DRAWINGS

In the following description of the preferred embodiment, reference is made to the accompanying drawings which form a part hereof, and in which is shown by way of illustration a specific embodiment in which the invention may be practiced. It is to be understood that other embodiments may be utilized and structural changes may be made without departing from the scope of the present invention. Referring now to the drawings in which like reference numbers represent corresponding parts throughout:

FIG. 1 shows selected biobased and renewable multifunctional epoxy compounds (MEC).

FIG. 2 shows selected aldehyde functionalized compounds.

FIG. 3 shows selected approach for making novel epoxy prepolymers.

FIG. 4 demonstrates the approach for making VANB.

FIG. 5 demonstrates the water resistance tests of selected thermosets.

FIG. 6 demonstrates the approach for making VANG.

### DETAILED DESCRIPTION

The existing epoxy based CFRC technology has several limitations, including the difficulties in degradation and recycling, and high value loss of carbon fiber, which significantly limits their development. Although technologies including pyrolysis, mechanical degradation and solvent treatment can degrade CFRCs into smaller fragments, these processes require harsh conditions like high temperature, high pressure or large amount of solvents. Meanwhile, the structure and sizing of recycled carbon fiber are significantly altered, which yield much lower mechanical properties and material value. It should be noted that the carbon fiber preparation process is energy intensive and consumes large amounts of solvent. Recycling carbon fiber from CFRCs without altering fiber structure and sizing has important economic and environmental benefits. Besides, 65-90% of the total CFRC cost comes from the carbon fiber itself. The high carbon fiber price affects its wide applications in automotive and other areas. If carbon fiber in CFRC can be recycled and reused, the material cost will be significantly reduced.

As mentioned above, conventional epoxy resin cannot be recycled because of the irreversible crosslinks. However, by incorporating dynamic covalent bonds into epoxy resin networks, the prepared resins can be degraded. The formed covalent adaptable networks (CANs), while still covalently cross-linked, can undergo reversible depolymerization and stress relaxation through cross-link cleavage and reformation/exchange.

Among the recognized dynamic bonds, the imine bond is privileged because it can undergo both associative (imine-amine exchange) and dissociative (imine hydrolysis and reformation) reactions. Imine bonds can be produced by reacting an aldehyde with a primary amine. Under acidic or basic conditions, imine bonds can be hydrolyzed into aldehyde and amine. Thus, if imine bonds can be incorporated into epoxy networks, the imine-containing resins can be decomposable and recyclable. In this disclosure, we describe novel epoxy prepolymers that bear terminal epoxy and aldehyde groups. When crosslinking with amine hardeners, the resulting imine-containing epoxy networks can be recyclable.

There are three innovations that distinguish this disclosure from the previously reported imine-containing epoxy thermosets. First, the synthesis of epoxy prepolymers in previous cases used either hydroxyl/epichlorohydrin reaction or epoxidation of alkene(s). By comparison, the disclosed epoxy prepolymers are prepared by reacting hydroxyl with multifunctional epoxy compounds (e.g., bisphenol A diglycidyl ether). No toxic reagent like epichlorohydrin is needed. Second, the synthesis of the disclosed epoxy precursors requires no solvent and no additional purification steps. The reaction mixture can be directly used for making thermosets. This is different from the conventional phenol-epichlorohydrin reactions in which excess epichlorohydrin is used as a solvent. The unreacted epichlorohydrin needs to be removed and epoxy prepolymers need to be purified in several steps. Third, the disclosed thermosets can be dissolved in common amine hardeners and the resulting mixture can still be used as an amine hardener to cure another batch of epoxy prepolymers. This degradation and recycling cycle can repeat for at least for 3 times without losing mechanical properties. Similar recycling patterns have never been reported before. One aspect of the present disclosure is an epoxy resin composition, which contains epoxy prepolymer (15-80 wt. %), amine hardener (10-60 wt. %), reactive diluent (0-30 wt. %), and accelerator for crosslinking reactions (0-5 wt. %).

The abovementioned epoxy prepolymers can be made by reacting multifunctional epoxy compounds (MEC) with aldehyde functionalized compounds (AFC).

Multifunctional epoxy compounds are chemical compounds that contain at least 2 epoxy groups per molecule. They can include, but are not limited to, bisphenol A type epoxy (bisphenol A diglycidyl ether), bisphenol F type epoxy (bisphenol F diglycidyl ether), bisphenol S type epoxy (bisphenol S diglycidyl ether), novolac type epoxy,d resorcinol diglycidyl ether, and combinations thereof. They can also include aliphatic epoxy compounds like neopentyl glycol diglycidyl ether, 1,4-butanediol diglycidyl ether, 1,3-propanediol diglycidyl ether, poly(propylene glycol) diglycidyl ether, poly(ethylene glycol) diglycidyl ether, trimethylolpropane triglycidyl ether, and 1,2,7,8-diepoxyoctane.

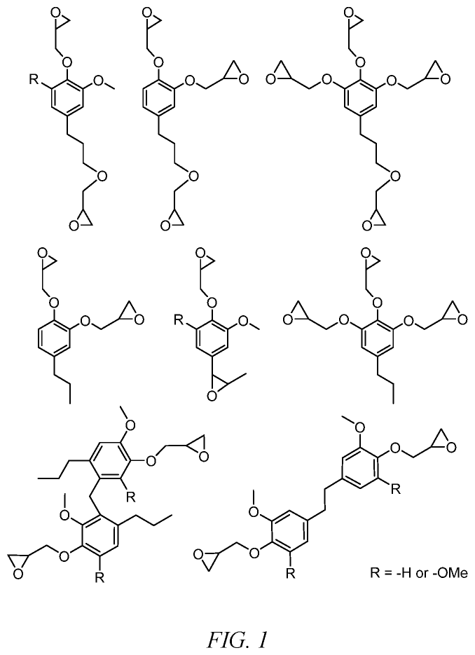

Multifunctional epoxy compounds can also include biobased epoxy compounds as illustrated in FIG. 1. In some embodiments, the epoxy group refers to the glycidyl type and cycloaliphatic type.

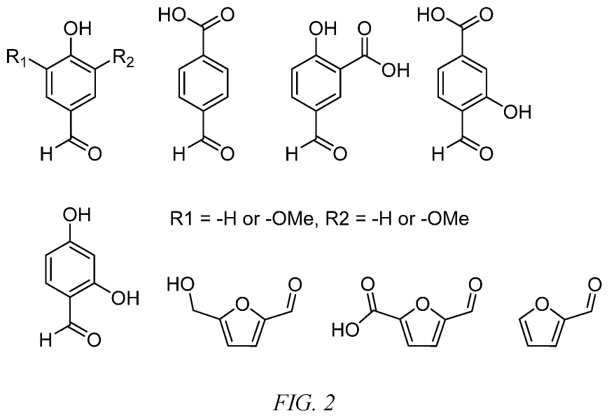

Aldehyde functionalized compounds include compounds that have at least one aldehyde group and at least one reactive group (e.g., hydroxyl, carboxylic acid and thiol etc.) that can open the epoxy ring. Aldehyde functionalized compounds can have any of the structures as shown in FIG. 2, but are not limited thereto.

The epoxy prepolymers can be prepared by reacting 1.0 molar equivalent of multifunctional epoxy compounds with 0.5-2.5 molar equivalents of aldehyde functionalized compounds in an organic solvent or under solvent-free conditions, with the optional aid of a catalyst. The mixture can be stirred at certain temperatures for a given time to obtain the desired product. In some aspects, the mixture can be combined and mixed at a temperature of between about 20-150° C. for a time of between about 1-48 hours.

While not wishing to be limited by theory, the reaction of interest proceeds when the reactive chemical group (e.g., hydroxyl, carboxylic acid, thiol, etc.) of an AFC reacts with and opens the epoxy group of one or more MECs. As a result, the prepared epoxy prepolymer as disclosed herein can have at least one epoxy group and at least one aldehyde group per molecule. When epoxy prepolymers are crosslinked with amine hardeners, two reactions can occur: 1) epoxy/amine reaction, and/or 2) aldehyde/amine reaction. The latter reaction can lead to reversible imine bonds, which makes the epoxy resin decomposable and recyclable.

In an embodiment, the catalyst can be a tertiary/quaternary amine compound or an imidazole compound or an inorganic base or any combination of them. Preferably, it can be 2,4,6-tris(dimethylaminomethyl)phenol, 2-ethyl-4-methylimidazole, 1-benzyl-2-methylimidazole, 1-cyanoethyl, tetra-n-butylammonium bromide, potassium hydroxide, sodium hydroxide, or any combination of the above, but not limited thereto.

In an embodiment, the organic solvents can include, but are not limited to, methylene chloride, tetrahydrofuran, ethyl acetate, iso propanol, chloroform, dioxane, pyridine, acetone, acetic acid, acetonitrile, ethanol, methanol, ethylene glycol, dimethylformamide (DMF), dimethyl sulfoxide (DMSO), and any combination thereof.

In some embodiments, the epoxy prepolymers can be achieved by drying the organic solvents at elevated temperature and/or under vacuum. Alternatively, the organic solvents can be kept with the epoxy prepolymers and separated (e.g., evaporated, etc.) later during the curing steps.

In some embodiments, the epoxy prepolymers can be prepared by heating above the melting point to achieve a liquid state mixture, without the use of a solvent.

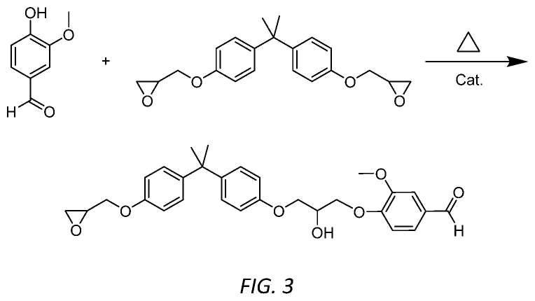

FIG. 3 illustrates a typical reaction for making the novel epoxy prepolymers. The hydroxyl group of vanillin (AFC) opens one epoxy group of bisphenol A diglycidyl ether (MEC) with the aid of a catalyst and heat, which forms the epoxy prepolymer with one epoxy group and one aldehyde group. It should be noted that this approach is not limited to vanillin and bisphenol A diglycidyl ether. All the above-mentioned AFC and MEC (FIG. 1 and FIG. 2) can undergo this reaction to make novel epoxy prepolymers.

A method for making the degradable and recyclable epoxy resin includes: mixing the epoxy prepolymer, amine hardener, reactive diluent, and accelerator in a container at room temperature or elevated temperature (e.g., between about 20-200° C.), degassing the mixture and curing the resin at an elevated temperature (e.g., between about 20-200° C.) for a time period of about 0.01-48 hours.

In an embodiment, the amine hardeners can include, but are not limited to, ethylenediamine, 1,4-butanediamine, diethylene triamine, triethylene tetramine, 1,8-diamino-4-azaoctane, neuridine, isophoronediamine, 1,8-diamino-p-menthane, 1,3-bis(aminomethyl)cyclohexane, 4-methylcyclohexane-1,3-diamine, 4,4′-diaminodicyclohexylmethane, 4,4′-methylenebis(2-methylcyclohexylamine), m-xylylenediamine, p-xylylenediamine, o-xylylenediamine, trans-1,4-diaminocyclohexane, 1,2-diaminocyclohexane, and/or Jeffamine®. It can be a single amine hardener or any combination of the above, but not limited thereto.

In an embodiment, the reactive diluent can include, but is not limited to, a phenyl glycidyl ether, cresol glycidyl ether, neopentyl glycol diglycidyl ether, glycol diglycidyl ether, butanediol diglycidyl ether, glycidyl methacrylate, tertiary carboxylic acid glycidyl ester, diglycidyl aniline, trimethylolpropane triglycidyl ether, glycerol triglycidyl glyceryl ether diglycidyl ether, polyglycol diglycidyl ether, polypropylene glycol diglycidyl ether, n-butyl glycidyl ether, allyl glycidyl ether, 5-ethyl hexyl glycidyl ether, epoxidized soybean oil, epoxidized cashew nut shell liquid, styrene oxide, and/or benzyl alcohol. It can be a single diluent or any combination of the above, but not limited thereto.

In an embodiment, the accelerators used to increase the rate of epoxy-amine curing reactions include, but are not limited to tertiary/quaternary amine compound, an imidazole compound, an inorganic base, or any combination of them. In some embodiments, the accelerator can be 2,4,6-tris(dimethylaminomethyl)phenol, 2-ethyl-4-methylimidazole, 1-benzyl-2-methylimidazole, 1-cyanoethyl, tetra-n-butylammonium bromide, potassium hydroxide, sodium hydroxide, or any combination of the above, but not limited thereto.

The resin(s) can optionally be combined with other materials to form composite materials. Additional components can include, but are not limited to, monomers, polymers, fillers, plasticizers, fibers (e.g., carbon fibers, glass fibers, etc.), metals, glass, wood, flame retardants, pigments, dyes, antioxidants, lubricants, and combinations thereof. Additional components can optionally be mixed with the epoxy precursor and cross-linking hardener to form a composite material. Mixing of the epoxy prepolymer, cross-linking hardener and additional components can be performed by dissolving the materials in a solvent or as a neat condition where no solvent is used. Solvents in which the composite precursor can be dissolved include, but are not limited, to N, N-dimethylformamide, ethanol, methanol, toluene, benzene, THF, dimethyl sulfoxide, ethyl acetate, isopropyl alcohol, or any combination thereof. After mixing the composite precursor, the mixture can optionally be poured into a mold and heated at between about 20-200° C. for between about 0.01-48 hours to yield a composite. If solvent was used in previous steps, the solvent can be removed by evaporation by applying a vacuum and/or heat to the system.

Once formed, the resin/composite can be coated with a composition to improve the resistance to various chemicals including water and/or solvents. This composition can be a conventional BPA-based epoxy coating. Other protective coating materials can also be applied for additional surface protection. In addition to or in place of a coating, one or more additives can be added into the thermoset composition during formation to improve water and/or solvent resistance of the resulting thermoset composition.

Additionally, the epoxy resins described herein can be resistant to various solvents including benzene, toluene, tetrahydrofuran (THF), ethanol, N,N-dimethylformamide (DMF), dimethyl sulfoxide (DMSO) and water at elevated temperature, with less than 10% mass loss when immersed in the respective solvents at 65° C. for 24-72 hours.

The prepared epoxy resins can be decomposed and dissolved in organic solvents or amines. The decomposition method includes immersing the epoxy resin in acidified solvents or amine solutions, stirring/circulating the mixture at a temperature between about 20-100° C. for between 2-12 h to get fully dissolved epoxy resin solution.

In some embodiments, the solvents used for dissolving the prepared epoxy resins can include, but are not limited to, water, methylene chloride, tetrahydrofuran, ethyl acetate, iso-propanol, chloroform, dioxane, pyridine, acetone, acetic acid, acetonitrile, ethanol, methanol, ethylene glycol, dimethylformamide, dimethyl sulfoxide, or any combination thereof.

In an embodiment, an acid such as hydrochloric acid can be used to depolymerize the thermosets. This selection is based on its strong acidity, compatibility with hydrophilic solvent and low boiling point that can be readily removed along with solvent during the drying process. Other acids that can dissociate the imine bonds within the thermoset can also be used. These acids include, but are not limited to: inorganic acids including, nitric acid, sulfuric acid, chloric acid, perchloric acid, hydrobromic acid and hydroiodic acid; organic acids including formic acid, acetic acid, propionic acid, oxalic acid, lactic acid, p-toluenesulfonic acid, aminomethylphosphonic acid, and combinations thereof; and solid acids including silico-aluminates (zeolites, alumina, silico alumino-phosphate), sulfated zirconia, metal oxides (titania and zirconia), sulfonated polystyrene, solid phosphoric acid, and combinations thereof.

In an embodiment, using the above degradation method, the prepared epoxy resins can also be depolymerized in amine solutions. The amine solutions can include, but are not limited to, ethylenediamine, 1,4-butanediamine, diethylene triamine, triethylene tetramine, 1,8-diamino-4-azaoctane, neuridine, isophoronediamine, 1,8-diamino-p-menthane, 1,3-bis(aminomethyl)cyclohexane, 4-methylcyclohexane-1,3-diamine, 4,4′-diaminodicyclohexylmethane, 4,4′-methylenebis(2-methylcyclohexylamine), m-xylylenediamine, p-xylylenediamine, o-xylylenediamine, trans-1,4-diaminocyclohexane, 1,2-diaminocyclohexane, Jeffamine®, and combinations thereof.

The weight ratio of epoxy resin to solvent can be between about 1:2 to 1:15.

In some cases, the recyclable thermosets presented herein may be formulated as composites incorporating fillers including but not limited to monomers, polymers fillers, plasticizers, carbon fiber, glass fiber, metals, glass, wood, flame retardants, pigments, dyes, antioxidants, lubricants, or any combination thereof. When recyclable thermosets containing fillers are treated with solvent, acid or amine, and optional heat using methods designed to depolymerize the thermoset, the fillers can be recovered by filtration or other means of separation and selectively isolated from the depolymerized thermoset without damaging the structure of the fillers.

Following optional removal of optional fillers, solvent and acid can be removed from the dissolved thermoset by several processes including, but not limited to, evaporation. In some cases, the mixture of acid, solvent, and depolymerized thermoset can be heated to between about 25-200° C. for about 0.5-72 hours to remove acid and/or solvent. This step can be carried out to produce a mixture having desired properties. In some embodiments, removal of solvent and acid from the depolymerized thermoset can be stopped before complete removal of solvent and/or acid to allow the mixture to remain in a flowable or processable state. The mixture can optionally be transferred to a mold in which the thermoset can optionally be repolymerized. The remaining solvent and acid can be removed from the depolymerized thermoset by heating at between about 25-200° C. for about 0.5-72 hours. As the remaining acid and/or solvent is removed, the depolymerized thermoset can be allowed to re-polymerize. Optionally, fillers including, but not limited to, monomers, polymers fillers, plasticizers, carbon fiber, glass fiber, metals, glass, wood, flame retardants, pigments, dyes, antioxidants, lubricants, or any combination thereof can be added to the depolymerized thermoset prior to complete repolymerization to form a composite.

The mild conditions used to degrade the invented thermosets allow for substantial (e.g., greater than 90 wt. %, greater than 95 wt. %, near complete, etc.) recycling of the carbon fiber from CFRCs without damaging the fiber structure or decreasing mechanical strength.

Recycling the epoxy resin can be achieved through solvent-aided or solvent-free approaches. For solvent-aided method, the epoxy resin can first be depolymerized in organic reagent to achieve a homogenous solution using the above degradation method. The organic reagent is then evaporated at between about 65-100° C. for about 0.5-12 hours to achieve a polymer gel. The gel can be further heated at between about 120-200° C. to repolymerize the network and recover the thermosets.

Alternatively, the epoxy resin can be decomposed in an amine solution. This amine solution can be used as amine hardener to cure another batch of epoxy prepolymer, which completes the recycling.

Both acid and amine can be used to cleave the imine bonds within the network. As a result, the epoxy resin network is converted into smaller polymers and oligomers and can be dissolved in solvents.

In certain embodiments, additional components can be introduced during the recycling process to obtain thermoset with different compositions compared to the original thermoset. In an embodiment, the additional components include, but are not limited to, monomers, polymers fillers, plasticizers, fibers, metals, glass, wood, flame retardants, pigments, dyes, antioxidants, lubricants.

In an embodiment, the fiber materials can include carbon fiber and/or glass fiber.

The mild conditions used to recycle the invented thermosets allow for substantial (e.g., greater than 90 wt. %, greater than 95 wt. %, near complete, etc.) recycling of the carbon fiber from CFRCs without damaging the fiber structure or decreasing mechanical strength. This approach is more advantageous than the recycling of conventional carbon fiber composites by pyrolysis, in which the chopped carbon fibers lose significant strength and value (>90%) while no thermoset matrix can be recovered.

For solvent-free recycling approach, the resin can be first crushed into powder and press molded at between about 100-250° C. and about 0.1-2.0 MPa for about 0.5-5 hours to recover the resin.

### EXAMPLES

The embodiments having been generally described, the following examples are given as particular embodiments of the disclosure and to demonstrate the practice and advantages thereof. It is understood that the examples are given by way of illustration and are not intended to limit the specification or the claims in any manner.

### Example 1

### Preparation of Epoxy Prepolymer

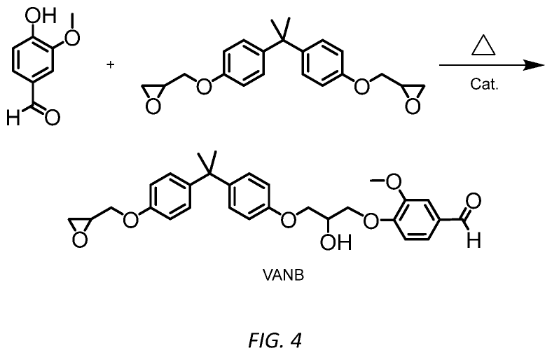

3.40 g of bisphenol A diglycidyl ether, 1.52 g of vanillin and 0.025 g of 2-ethyl-4-methylimidazole were introduced in a 20 mL vial. The mixture was stirred at 85° C. for 2 hours to achieve the desired epoxy prepolymer (VANB, 90%) as an amber solid. The reaction pathway is shown in FIG. 4.

### Formation of Epoxy Resins.

1.5 g of VANB was mixed with 388 mg of isophoronediamine (amine hardener) and 1.05 g of benzyl alcohol in a vial. The mixture was vigorously stirred at 70° C. to achieve a homogenous mixture, poured into a mold and heated at 80° C. for 4 hours and 140 C for 4 hours to afford the cured epoxy resin EN-VANB with brown color.

Infrared spectrum of the resin exhibited the total disappearance of the signals for epoxy group (912 cm⁻¹), while the bond of hydroxyl groups increased, suggesting most epoxy groups have been reacted. Imine bonds were also observed at 1610 cm⁻¹ from the infrared spectrum, indicating reaction occurred between aldehyde and amine.

### Degradation of the Epoxy Resin.

The prepared epoxy resin could be transformed into soluble polymers using proper depolymerization conditions. 1.5 g of EN-VANB was cut into pieces (ca. 12.5 mm L×5 mm W×2 mm T) and placed in a 50 mL glass vial. To this vial was added 25 mL of isophoronediamine solution and stirred at 80° C. for 2 hours. The epoxy resin was found to be 100% dissolved in solution.

### Process for Recycling the Resin

259 mg of the above epoxy resin solution was directly mixed with 1 g of VANB and 0.7 g of benzyl alcohol (to reach 1:1 molar ratio of epoxy:—NH and 1:1 molar ratio of aldehyde:—NH₂). The mixture was thoroughly mixed to achieve a homogenous solution. The solution was heated at 80° C. for 4 hours and 140° C. for 4 hours to achieve the recycled resin with brown color.

### CFRCs Using the Proposed Resin as Matrix can be Recycled

A CFRC sheet (100 mm×80 mm×1 mm) comprised of commercial carbon fiber and the EN-VANB resin as described herein was prepared via hand lamination. The CFRC sheet was immersed in 100 mL of isophoronediamine solution and heated at 80° C. for 3 hours. The thermoset matrix can be dissolved into amine solution, while the leftover carbon fiber remained intact and could be easily reused. Using the thermoset recycling method as demonstrated above, a new carbon fiber composite can be made from both recycled thermoset and carbon fiber. This approach is more advantageous than the recycling of conventional carbon fiber composites by pyrolysis, in which the chopped carbon fibers lose significant strength and value (>90%) while no thermoset matrix can be recovered.

### Water Resistance of VANB-Based Resins

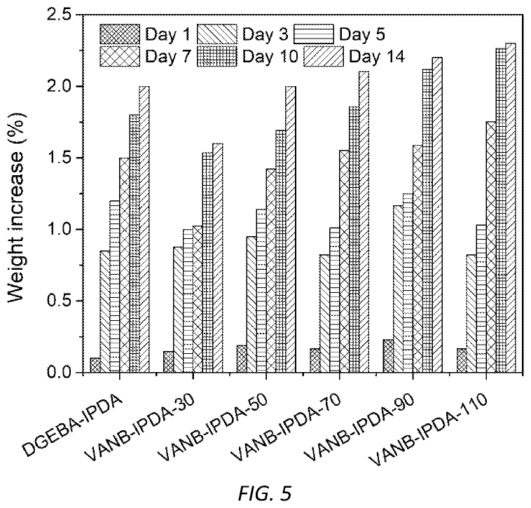

Water resistance test was conducted using VANB-based resins. Different VANB/benzyl alcohol ratios (1:0.3 to 1:1.1) were used to tune the viscosity of the epoxy prepolymers. IPDA was used to cure the prepolymers using 1:1 molar ratio of epoxy:—NH and 1:1 molar ratio of aldehyde:—NH₂. A control resin was also prepared using DGEBA and IPDA with 1:1 molar ratio of epoxy:—NH. The preparation method for VANB and DGEBA based resins is same. For water resistance test, all resins (30 mm×10 mm×0.5 mm) were immersed in water at room temperature. At different times, the samples were collected from the water, wiped off surface water and weighed. The relation between weight increase (%) and time is shown in FIG. 5. In FIG. 5, VANB based resins were abbreviated as VANB-IPDA-X, where X is the % of benzyl alcohol/VANB. For example, VANB-IPDA-30 represents the resin prepared from epoxy mixture (in which benzyl alcohol and VANB weight ratio=30:100) and IPDA. As can be seen in FIG. 5, VANB-based samples exhibited weight increase between 1.6-2.3% after immersing in water for 14 days. This is comparable to the DGEBA based resins (2.0%), which indicates good water resistance of the VANB resins.

### Example 2

### Preparation of Epoxy Prepolymer

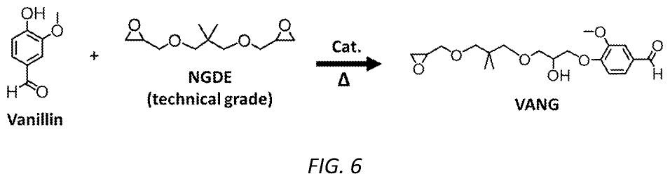

5.4 g of neopentyl glycol diglycidyl ether (technical grade), 1.52 g of vanillin and 0.05 g of 2-ethyl-4-methylimidazole were introduced in a 20 mL vial. The mixture was stirred at 85° C. for 5 hours to achieve the desired epoxy prepolymer (VANG) as a dark yellow liquid. The reaction pathway for making VANG is shown in FIG. 6.

### Formation of Epoxy Resins.

1.5 g of VANG was mixed with 0.45 g of isophoronediamine (amine hardener) in a vial. The mixture was vigorously stirred at 40° C. to achieve a homogenous mixture, poured into a mold and heated at 80° C. for 4 hours and 140° C. for 4 hours to afford the cured epoxy resin EN-VANG with yellowish color.

Infrared spectrum of the resin exhibited the total disappearance of the signals for epoxy group (912 cm⁻¹), while the bond of hydroxyl groups increased, suggesting most epoxy groups have been reacted. Imine bonds were also observed from the infrared spectrum, indicating reaction occurred between aldehyde and amine.

### Degradation of the Epoxy Resin.

The prepared epoxy resin could be transformed into soluble polymers using proper depolymerization conditions. 1.5 g of EN-VANG was cut into pieces (ca. 12.5 mm L×5 mm W×2 mm T) and placed in a 50 mL glass vial. To this vial was added 25 mL of isophoronediamine solution and stirred at 80° C. for 2 hours. The epoxy resin was found to be 100% dissolved in solution.

### Process for Recycling the Resin

0.3 g of the above degradation solution was directly mixed with 1 g of VANG. The mixture was thoroughly mixed to achieve a homogenous solution. The solution was heated at 80° C. for 4 hours and 140° C. for 4 hours to achieve the recycled resin with yellowish color.

### CFRCs Using the Proposed Resin as Matrix can be Recycled

A CFRC sheet (100 mm×80 mm×1 mm) comprised of commercial carbon fiber and the EN-VANG resin as described herein was prepared via hand lamination. The CFRC sheet was immersed in 100 mL of isophoronediamine solution and heated at 80° C. for 3 hours. The thermoset matrix can be dissolved into amine solution, while the leftover carbon fiber remained intact and could be easily reused. Using the thermoset recycling method as demonstrated above, a new carbon fiber composite can be made from both recycled thermoset and carbon fiber.

Having described various compositions and methods, certain aspect can include, but are not limited to:

In a first aspect, a thermoset composition comprises: an epoxy prepolymer, an amine hardener, a reactive diluent, and an accelerator for crosslinking reactions.

A second aspect can include the composition of the first aspect, wherein the epoxy prepolymer is present in an amount of between 15-80 wt. %, wherein the amine hardener is present in an amount of between 10-60 wt. %, wherein the reactive diluent is present in an amount of between 0-30 wt. %, and wherein the accelerator is present in an amount of between 0-5 wt. %).

A third aspect can include the composition of the first or second aspect, wherein the epoxy prepolymer comprises at least one terminal epoxy group and at least one terminal aldehyde group.

A fourth aspect can include the composition of the third aspect, wherein the epoxy prepolymers are the reaction product of a multifunctional epoxy compounds with aldehyde functionalized compounds.

A fifth aspect can include the composition of the fourth aspect, wherein the multifunctional epoxy compounds are chemical compounds that contain at least 2 epoxy groups per molecule.

A sixth aspect can include the composition of the fifth aspect, wherein the multifunctional epoxy compounds comprise bisphenol A type epoxy (bisphenol A diglycidyl ether), bisphenol F type epoxy (bisphenol F diglycidyl ether), bisphenol S type epoxy (bisphenol S diglycidyl ether), and novolac type epoxy. They include aliphatic epoxy compounds like neopentyl glycol diglycidyl ether, 1,4-butanediol diglycidyl ether, 1,3-propanediol diglycidyl ether, poly(propylene glycol) diglycidyl ether, poly(ethylene glycol) diglycidyl ether, trimethylolpropane triglycidyl ether, 1,2,7,8-diepoxyoctane, or a biomass derived epoxy compound.

In a seventh aspect, a method for making the degradable and recyclable epoxy resin comprises: mixing an epoxy prepolymer, an amine hardener, a reactive diluent, and an accelerator to form a mixture; degassing the mixture; and curing the mixture to for a resin.

An eighth aspect can include the method of the seventh aspect, wherein curing the mixture comprises curing the mixture at 20-200° C. for 0.01-48 hours.

A ninth aspect can include the method of the seventh or eighth aspect, wherein the epoxy prepolymer, the amine hardener, the reactive diluent, and the accelerator are mixed in a container at a temperature of between 20-200° C.

A tenth aspect can include the method of any one of the seventh to ninth aspects, further comprising forming the epoxy prepolymers by reacting 1.0 molar equiv. of multifunctional epoxy compounds with 0.5-2.5 molar equiv. of aldehyde functionalized compounds in an organic solvent or under solvent-free condition, with the aid of a catalyst.

An eleventh aspect can include the method of any one of the seventh to tenth aspects, further comprising combining the resin with one or more additional materials to form a composite material.

A twelfth aspect can include the method of the eleventh aspect, wherein the one or more additional materials comprise carbon fiber or glass fiber.

A thirteenth aspect can include the method of any one of the seventh to twelfth aspects, further comprising coating the resin with a coating composition, wherein the coating composition is selected to improve a resistance to water, organic solvents, or a combination thereof.

A fourteenth aspect can include the method of any one of the seventh to thirteenth aspects, further comprising: decomposing the resin and dissolving the resin in an organic solvent or an amine.

A fifteenth aspect can include the method of the fourteenth aspect, wherein decomposing the resin and dissolving the resin comprises: immersing the resin in an amine solution; circulating the resin in the amine solution at 20-100° C. for 0.1-12 hours; and fully dissolving the resin in the amine solution.

A sixteenth aspect can include the method of the fourteenth or fifteenth aspect, further comprising: chemically recycling the resin after dissolving the resin in the organic solvent or the amine.

An eighteenth aspect can include the method of the sixteenth or seventeenth aspect, wherein the recycled resin has comparable (>90%) thermal and mechanical properties (glass transition temperature, modulus, tensile strength etc.) as the original resin.

A nineteenth aspect can include the composition of any one of the first to sixth aspects or the method of any one of the seventh to eighteenth aspects, wherein the resin is used in one or more industrial applications including automotive, aerospace, wind turbine, adhesive, coating, sporting goods, or any combination thereof.

Aspects and embodiments are discussed herein with reference to the Figures. However, those skilled in the art will readily appreciate that the detailed description given herein with respect to these figures is for explanatory purposes as the systems and methods extend beyond these limited embodiments. For example, it should be appreciated that those skilled in the art will, in light of the teachings of the present description, recognize a multiplicity of alternate and suitable approaches, depending upon the needs of the particular application, to implement the functionality of any given detail described herein, beyond the particular implementation choices in the following embodiments described and shown. That is, there are numerous modifications and variations that are too numerous to be listed but that all fit within the scope of the present description. Also, singular words should be read as plural and vice versa and masculine as feminine and vice versa, where appropriate, and alternative embodiments do not necessarily imply that the two are mutually exclusive.

It is to be further understood that the present description is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present systems and methods. It must be noted that as used herein and in the appended claims (in this application, or any derived applications thereof), the singular forms “a,” “an,” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this description belongs. Preferred methods, techniques, devices, and materials are described, although any methods, techniques, devices, or materials similar or equivalent to those described herein may be used in the practice or testing of the present systems and methods. Structures described herein are to be understood also to refer to functional equivalents of such structures. The present systems and methods will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although claims may be formulated in this application or of any further application derived therefrom, to particular combinations of features, it should be understood that the scope of the disclosure also includes any novel feature or any novel combination of features disclosed herein either explicitly or implicitly or any generalization thereof, whether or not it relates to the same systems or methods as presently claimed in any claim and whether or not it mitigates any or all of the same technical problems as do the present systems and methods.

Features which are described in the context of separate embodiments may also be provided in combination in a single embodiment. Conversely, various features which are, for brevity, described in the context of a single embodiment, may also be provided separately or in any suitable sub-combination. The Applicant(s) hereby give notice that new claims may be formulated to such features and/or combinations of such features during the prosecution of the present Application or of any further Application derived therefrom.

What is claimed is:

1. A thermoset composition comprising:
an epoxy prepolymer,
an amine hardener,
a reactive diluent, and
an accelerator for crosslinking reactions.

2. The composition of claim 1, wherein the epoxy prepolymer is present in an amount of between 15-80 wt. %,
wherein the amine hardener is present in an amount of between 10-60 wt. %,
wherein the reactive diluent is present in an amount of between 0-30 wt. %, and
wherein the accelerator is present in an amount of between 0-5 wt. %).

3. The composition of claim 1, wherein the epoxy prepolymer comprises at least one terminal epoxy group and at least one terminal aldehyde group.

4. The composition of claim 3, wherein the epoxy prepolymers are the reaction product of a multifunctional epoxy compounds with aldehyde functionalized compounds.

5. The composition of claim 4, wherein the multifunctional epoxy compounds are chemical compounds that contain at least 2 epoxy groups per molecule.

6. The composition of claim 5, wherein the multifunctional epoxy compounds comprise bisphenol A type epoxy (bisphenol A diglycidyl ether), bisphenol F type epoxy (bisphenol F diglycidyl ether), bisphenol S type epoxy (bisphenol S diglycidyl ether), and novolac type epoxy. They include aliphatic epoxy compounds like neopentyl glycol diglycidyl ether, 1,4-butanediol diglycidyl ether, 1,3-propanediol diglycidyl ether, poly(propylene glycol) diglycidyl ether, poly(ethylene glycol) diglycidyl ether, trimethylolpropane triglycidyl ether, 1,2,7,8-diepoxyoctane, or a biomass derived epoxy compound.

7. The composition of claim 1, wherein the resin is used in one or more industrial applications including automotive, aerospace, wind turbine, adhesive, coating, sporting goods, or any combination thereof.

8. The composition of claim 1, further comprising one or more additional materials mixed with the thermoset composition, wherein the mixture of the one or more additional materials and the thermoset composition is a composite material.

9. A method for making the degradable and recyclable epoxy resin, the method comprising:
mixing an epoxy prepolymer, an amine hardener, a reactive diluent, and an accelerator to form a mixture;
degassing the mixture; and
curing the mixture to for a resin.

10. The method of claim 9, wherein curing the mixture comprises curing the mixture at 20-200° C. for 0.01-48 hours.

11. The method of claim 9, wherein the epoxy prepolymer, the amine hardener, the reactive diluent, and the accelerator are mixed in a container at a temperature of between 20-200° C.

12. The method of claim 9, further comprising forming the epoxy prepolymers by reacting 1.0 molar equiv. of multifunctional epoxy compounds with 0.5-2.5 molar equiv. of aldehyde functionalized compounds in an organic solvent or under solvent-free condition, with the aid of a catalyst.

13. The method of claim 9, further comprising combining the resin with one or more additional materials to form a composite material.

14. The method of claim 11, wherein the one or more additional materials comprise carbon fiber or glass fiber.

15. The method of claim 9, further comprising coating the resin with a coating composition, wherein the coating composition is selected to improve a resistance to water, organic solvents, or a combination thereof.

16. The method of claim 9, further comprising:
decomposing the resin and dissolving the resin in an organic solvent or an amine.

17. The method of claim 16, wherein decomposing the resin and dissolving the resin comprises:
immersing the resin in an amine solution;
circulating the resin in the amine solution at 20-100° C. for 0.1-12 hours; and
fully dissolving the resin in the amine solution.

18. The method of claim 16, further comprising:
chemically recycling the resin after dissolving the resin in the organic solvent or the amine.

19. The method of claim 18, wherein the recycled resin has comparable (>90%) thermal and mechanical properties (glass transition temperature, modulus, tensile strength etc.) as the original resin.

20. The method of claim 9, wherein the resin is used in one or more industrial applications including automotive, aerospace, wind turbine, adhesive, coating, sporting goods, or any combination thereof.
